(19) United States
(12) Patent Application Publication
(10) Pub. No.: US 2003/0196194 A1
(43) Pub. Date: Oct. 16, 2003

(54) Hardware design protocol and system

(76) Inventors: Clifford R. Johns, Wheaton, IL (US); David A. Pierce, Wheaton, IL (US)

Correspondence Address: Richard J. Minnich, Esq., Fay, Sharpe, Fagan, Minnich & McKee, LLP., Seventh Floor, 1100 Superior Avenue, Cleveland, OH, 44114, US

(21) Appl. No.: 09/975,113

(22) Filed: Oct. 11, 2001

(51) Int. Cl. G06F 9/45; G06F 17/50

(52) U.S. Cl. 717/136; 716/4

(57) ABSTRACT

A method of designing hardware includes entering source code into a source code file. The source code uses a context-free grammar that describes a job the hardware being designed has to do rather than describing an implementation of the hardware. The method also includes compiling the source code file to generate an output file which describes an optimized state machine for implementing the hardware. The output file is written in a C-based code which is then translated to a HDL (e.g., VHDL or Verilog).

### BACKGROUND OF THE INVENTION

The present invention relates to art of hardware design. It finds particular application in conjunction with the design of application specific integrated circuits (ASICs) and/or field programmable gate arrays (FPGAs), and will be described with particular reference thereto. However, it is to be appreciated that the present invention is also amenable to other like applications.

Engineers and the like have been able to design hardware for ASICs and FPGAs using a design language rather than schematic representations for some time. There are several languages available including very high speed integrated circuit hardware description language (VHDL), Verilog, C variations and other languages that are used for hardware design. These languages, however, merely describe the implementation of the hardware. The usual design entry methods (i.e., schematic capture, graphical state machine editors, register-transfer-level (RTL) and behavioral languages) focus on describing the combinatorial and next-state logic that implements the circuit-under design (CUD). This description of the implementation tends to be long and not easily understood.

The present invention contemplates a new and improved hardware design protocol and system which overcomes the above-referenced problems and others.

### SUMMARY OF THE INVENTION

In accordance with one aspect of the present invention, a method of designing hardware is provided. The method includes entering source code into a source code file. The source code uses a context-free grammar that describes a job the hardware being designed has to do rather than describing an implementation of the hardware. The method also includes compiling the source code file to generate an output file which describes an optimized state machine for implementing the hardware. Preferably, the output file is written in a C-based code. Alternately, the output file is written in HDL, VHDL, Verilog or the like.

In accordance with another aspect of the present invention, computer software for designing hardware resides on a computer-readable medium. The software includes a compiler which generates from source code an output file that describes an optimized state machine for implementing hardware. The source code uses a context-free grammar that describes a job that the hardware being designed has to do, and said output file is written in a C-based language.

In accordance with another aspect of the present invention, a system for designing hardware includes a computer having means for entering an input file written in a source code that uses a context-free grammar which describes a job that hardware being designed has to do. A compiler runs on the computer, and the compiler selectively converts the input file into an output file which is written in a C-based code. The output file describes an optimized state machine for implementing the hardware being designed.

One advantage of the present invention resides in its ability to help a hardware design engineer break down a hardware design problem into a sequence of events rather than a sequence of state machine states and thereby enables a hierarchical view of the sequence of events. Relative to specifying machine states and transitions, the described sequences of events are generally closer in form to original specifications. Another advantage of the present invention resides in its ability to minimize the level and complexity of the design information the engineer has to enter.

A further advantage of the present invention is that it promotes specification of the machine behavior at a high level of abstraction, followed by successive refinement of the behavior down to a level suitable for synthesizing the detailed machine. The hierarchical nature of the specification makes it easy to understand and modify. Insomuch as the descriptions are concise and easy to follow, significant design changes can be made with relatively little effort and a low probability of error. Additionally, the sequence notation of the description, in contrast to a description of states and transitions, has a strong correlation to the form of both the input requirements and simulation waveform display, making it easier to understand the design intent, and find and fix errors.

Still further advantages and benefits of the present invention will become apparent to those of ordinary skill in the art upon reading and understanding the following detailed description of the preferred embodiments.

### BRIEF DESCRIPTION OF THE DRAWING(S)

The invention may take form in various components and arrangements of components, and/or in various steps and arrangements of steps. The drawings are only for purposes of illustrating preferred embodiments and are not to be construed as limiting the invention.

FIG. 1 is a flow chart illustrating a hardware design protocol in accordance with aspects of the present invention.

FIG. 2 is an timing or pulse diagram for the transmit side of an exemplary UART.

FIG. 3 is a state diagram corresponding to the UART shown in FIG. 2.

### DETAILED DESCRIPTION OF THE PREFERRED EMBODIMENT(S)

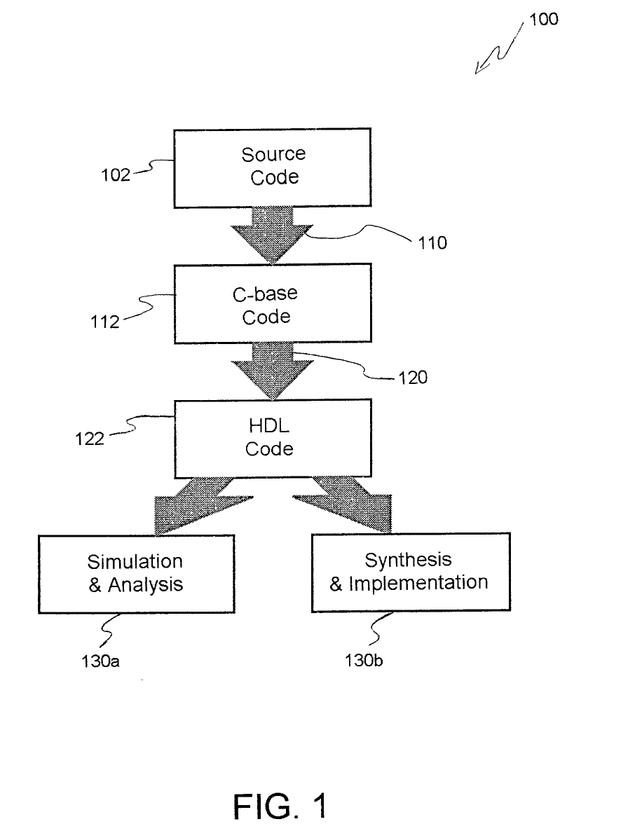

With reference to FIG. 1, the flow chart illustrates a hardware design protocol 100 in accordance with aspects of the present invention that employs a novel programming language and associated compiler to arrive at finite state machine implementations of hardware designs. The protocol 100 is particularly useful for designing ASICs, FPGAs, computer programmable logic devices (CPLDs), etc. It is, however, also useful for designing other implementations of finite state machines.

Via a computer, a hardware design engineer or other user creates and/or enters the particular code for a desired hardware design using the novel programming language of the present invention. Preferably, the code is entered as text and saved or otherwise stored as a source program file 102. Any suitable text editor may be employed to create, enter and/or edit the code. At step 110, the associated compiler acting on the source program file or source code 102 is used to generate a high level C-based code or pseudocode (i.e., the output code or file 112) which is readily translated into VHDL code or other HDL code representing the designed hardware, an RTL-based description of the designed hardware, or the like. The compiler converts the program file 102 written in the source programming language into a high level C-based code or pseudocode that represents an optimized finite state machine for implementing the hardware under design.

At step 120, the output code 112 is optionally translated into VHDL code or other HDL code representing the designed hardware, an RTL-based description of the designed hardware, or the like. The translated output code is preferably saved or otherwise stored in a translated program file 122. The translated program file 122 may then be used in the usual manner for its format to conduct simulations and analysis of the hardware designed (step 130a), or to conduct the synthesis and implementation of the hardware designed (step 130b). Essentially, the present invention provides a front end for a typical RTL-based design flow. The generated code 112 follows the ordinary rules for C-based programming, requiring no special libraries or translation options. Downstream tools and processes operate unaware of the manner in which the RTL code was generated.

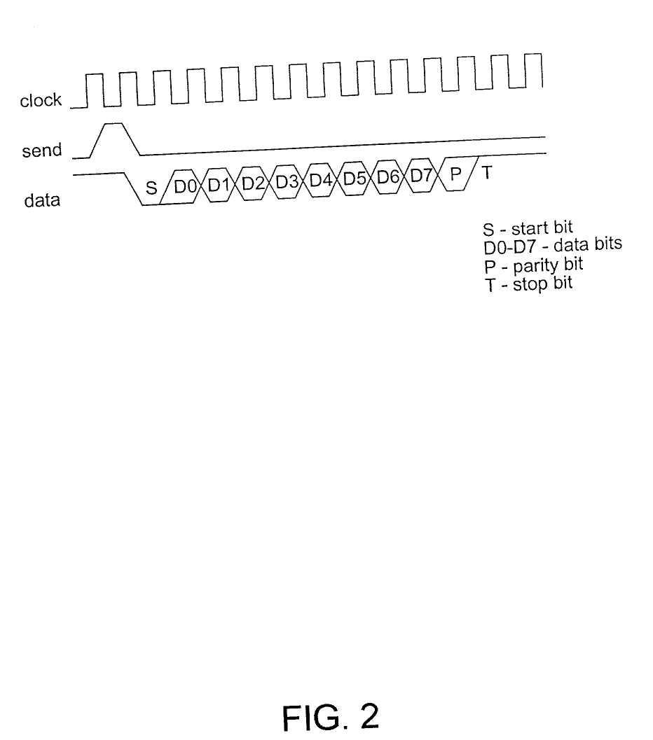

For example, the transmit side of a simple universal asynchronous receiver/transmitter (UART) is considered. The transmit side of the UART can be described via the timing or pulse diagram shown in FIG. 2. In response to a send signal, the data signal, normally a ‘1’, is driven to a ‘0’ to indicate the start of the transmission. Eight bits of data, D0 through D7, are then sent, followed by a parity bit, P. In accordance with the stop bit, T, the data signal is then driven back to ‘1’.

In accordance with a preferred embodiment, the description of the UART transmit sequence in the source code 102 may look like the following:

| | |
|---|---|
| 1 | INPUT d[8], send; |
| 2 | OUTPUT data; |
| 3 | STATE parity; |
| 4 | uart: |

| | |
|---|---|
| 5 | data = 1 |

| | | |
|---|---|---|
| 6 | <> | (send==1), startbit, databyte, pbit, stopbit |
| 7 | ; | |
| 8 | | |

| | |
|---|---|
| 9 | startbit: { data = 0, parity = 0 }; |
| 10 | |
| 11 | databyte: { data = d[0->7], parity \hat{ } = d[0->7] }; |
| 12 | |
| 13 | pbit: data = parity; |
| 14 | |
| 15 | stopbit: data = 1; |

In this manner, the protocol or “language” for the UART is specified by describing its grammar. A grammar simply describes the sequences of symbols used for conveying information in a given language. The foregoing UART grammar is interpreted as:

data carries the value ‘1’ by default (line 5);

if there is a ‘send’ indication, step through the sequence startbit, databyte, pbit, and stopbit (line 6);

startbit is a single-cycle setting of data and parity to ‘0’ (line 9);

databyte is an eight-cycle sequence setting data to the value of d[0] through d[7], updating parity in each cycle (line 11);

pbit is a single-cycle setting of data to the value of parity (line 13); and

stopbit, the final stage in the sequence, is a single-cycle setting of data to the value ‘1’ (line 15).

From the foregoing formal description of the UART protocol, the present invention selectively generates both the transmit and/or receive state machines. An example of the generated code 112 for the transmitter is shown below:

| | | |
|---|---|---|
| uart2_t( ) { | COUTPUT data; | INPUT send; |
| INPUT d[8]; | | |
| RCLK clk; | case S3: | case S8: |

| | | |
|---|---|---|
| STATE par; | uart_fsm = S4; | uart_fsm = S9; |
| enum uart_fsm_type | data = d[1]; | data = d[6]; |
| {S0,S1,S2,S3,S4,S5, | par = par \hat{ } d[1]; | par = par \hat{ } d[6]; |
| S6,S7,S8,S9,S10,S11; | break; | break; |

| | | |
|---|---|---|
| STATE(uart_fsm_type) | case S4: | case S9: |

| uart_fsm = S0; | uart_fsm = S5; | uart_fsm = S10; |
|---|---|---|
| | data = d[2]; | data = d[7]; |
| switch(uart_fsm) { | par = par \hat{ } d[2]; | par = par \hat{ } d[7]; |
| | break; | break; |

case S0:

| | | |
|---|---|---|
| data = 1 ; | case S5: | case S10: |

| | | |
|---|---|---|
| if (send==1) { | uart_fsm = S6; | uart_fsm = S11; |

| | | |
|---|---|---|
| uart fsm = S1; | data = d[3]; | data = par; |

| | | |
|---|---|---|
| } | par = par \hat{ } d[3]; | break; |
| break; | break; | |

case S11:

| | | |
|---|---|---|
| case S1: | case S6: | uart_fsm = S0; |

| | | |
|---|---|---|
| uart_fsm = S2; | uart_fsm = S7; | data = 1; |
| par = 0; | data = d[4]; | break; |
| data = 0; | par = par \hat{ } d[4]; | |
| break; | break; | default: |

| | | uart_fsm = S0; |
|---|---|---|
| case S2: | case S7: | break; |

| uart_fsm = S3; | uart_fsm = S8; | |
|---|---|---|
| data = d[0]; | data = d[5]; | } /*End of uart_fsm |
| par = par \hat{ } d[0]; | par = par \hat{ } d[5]; | state machine */ |
| break; | break; | }. |

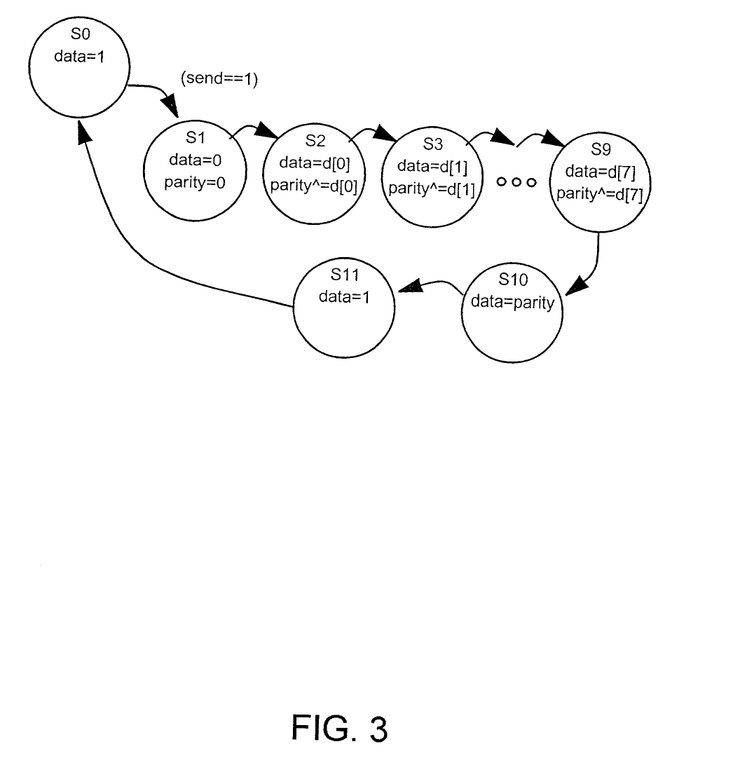

A corresponding state diagram for the generated transmitter is shown in FIG. 3 where S1 through S11 represent the each of the machine states.

### The Basic Design Structure

Hardware designs created with the present invention include and/or can be described in terms of a few basic elements. “Data objects” represent the input/output (IO) ports and internal signals that are the operands of the hardware module being designed. “Machines” are the finite state controllers that define the sequences of operations to be performed on data objects. “Nodes” provide the structure for defining the control logic for machines. “Start nodes” are nodes from which machines are built. “Sequences” describe the actions taken by the machine depending on its current state and the values of input signals. A node may comprise multiple alternative sequences. “Items” are the actions taken by machines as they traverse their allowable sequences. Item types include signal assignments, tests, waits, and references to nodes. “Concurrent items” are items in a sequence which are placed inside defined delimiters, namely, curly braces. Such a sequence will be executed in the same clock cycle. Of course, optionally a delimiter other than curly braces may be used.

In accordance with the design protocols of a preferred embodiment of the present invention, a machine is defined by a start node and all the sequences within nodes which are referenced directly or indirectly from that start node. In any one program file 102 representing a given hardware design, there may be multiple start nodes for multiple machines.

### Data Objects

Data objects are the signals and flip-flops and 10 of the hardware design. As is understood in the art, the data objects are for the most part the same as those usually associated with high level C-based hardware design protocols. They include the following:

INPUT represents a primary circuit input;

SIGNAL represents an internal signal which defaults to zero;

VARIABLE represents an internal signal which defaults to zero and forces implementation as VHDL variable;

LSIGNAL represents a latched internal signal which defaults to the current value;

COUTPUT represents a combinatorial output which defaults to zero and may be tristate-able;

LOUTPUT represents a latched output which defaults to the current value;

STATE represents an internal register which defaults to the current value;

SOUTPUT represents a registered output which defaults to the current value;

POUTPUT represents a registered output which defaults to zero;

IOPUT represents a bi-directional port which defaults to FLOAT, enable defaults to zero;

INTEGER represents a signed integer variable which defaults to zero; and,

PARAM represents a parameter which is equivalent to a VHDL generic, time, string or integer depending upon the initial value.

In addition to the above mentioned conventional data objects, the following three data objects are added:

CONSTANT symbolic_name=VALUE;

EXTERN signal₁₃ name; and

OUTPUT signal_name.

A CONSTANT provides a symbolic name for a less meaningful number. For example, if a known good CRC is 0x0A55, then one might use good_crc in the design and define it as a constant at the top of the program file as follows “CONSTANT good_crc=0x0A55”. EXTERN and OUTPUT are used for machines that will be reversed. When complied, EXTERN signals are made inputs on both the transmit and receive machines. An OUTPUT is converted to an INPUT when the machine is reversed just as an INPUT is converted to a COUTPUT. COUTPUTs are not transposed in this way. The generation of transmit and receive machines from the same design or program file 102 is dealt with in greater detail below.

Preferably, statements and expressions used to construct the source code 102 are substantially similar to other high level C-based programming languages with the addition of some forms of compressed notation for multi-state operations. See the Compressed Notation section below for more on the subject. A Backus Naur Form (BNF) like notation is preferably the notation used for describing the context free grammar of the present inventive programming language in which the source code 102 is written.

The definitions which follow are useful for understanding the invention presented herein. A context free grammar is, as the name suggests, a grammar that defines a language and is context free. The grammar consists of productions which show how the language is parsed. A production refers to a sequence of input tokens which together form a grammatical construct, and parsing refers to running an input stream through a grammar to see if that stream could be generated by that grammar (i.e., determining if a input stream is syntactically valid and exactly how it is determined to be syntactically valid). The syntax of a language defines what is valid in that language even if the semantic definition is meaningless. For example, the syntax of English will allow for syntactically valid sentences even with clauses that are otherwise meaningless gibberish.

Semantics refers to the actual meaning of a specific input sequence. In a syntax directed translation (i.e., mapping of input to output), the semantic actions define what to do with the signals and variables when a given syntactic structure is recognized (i.e., when a production is recognized). A translation scheme refers to a context free grammar where the semantic actions for the translation are included in the right hand side of the grammar. That is, when a production is recognized, what actions need to take place in the current state of the machine and the outputs of the machine.

### Nodes

Nodes represent a hierarchical level of the design description. A node includes within it a series (i.e., 1 or more) of options that define branching paths in a machine and each of these possible branches have a sequence of items which may include more nodes.

The first node in a program file 102, and optionally any node that is defined as a START node, represents the start of a machine. It is possible to include as many START nodes in a design file 102 as desired. Each one will create a separate machine within the same output file 112. In a preferred embodiment, the notation is as follows:

START [RCLK|FCLK clock_name] [ENABLE expression]
node_name:

series of options

;

For a START node, there is the option to define a clock and an enable for the respective machine. By default the resulting machine is enabled. See below for more on the ENABLE capability.

The clock may affect the machine on a rising or falling edge by specifying the RCLK or FCLK keyword. If not specified, a clock called ‘clk’ will be assumed and it will further be assumed that operations occur on the rising edge. For example,

START RCLK clk
node_name:

series of options

;

is the same as

START
node_name:

series of options

;

in the source code 102.

A node is made up of one or more options which represent paths of execution for the machine. One path is allowed to be the default path, but all other paths (options) must have tests at the beginning, so it can determine which path to take. For example, the code 102 may take the form:

nodea:

path1

<> (a!=1), path2
;

Further discussion of Options is found below.

As the compiler expands the design from node references, it looks through the full list of nodes in the source code 102. This means that the order of nodes in the design file 102 doesn't matter, with one exception. The first node in the file 102 is assumed to be a START node. The fact that order doesn't matter allows a designer to reuse a node in multiple machines without repeating the node definition. This also means that node names should be unique.

Preferably, node names are chosen to make a readable design file 102. For example, a node name like ‘nodea’ isn't terribly useful while a node name like ‘fill_transmit_buffer’ tells a reader of the design description exactly what happens in that node. Node references are like pseudo-code, the highest levels of the design should be almost readable as English. The following:

transfer_byte:

send_start_bit,
send_data_byte,
send_parity_bit,
send_stop_bit

;

is a good example of node names in a byte transferring operation. While this example may be a bit over done, it represents a style that makes even hard to understand operations simple to follow at the high level. This allows a designer to break up a problem and construct a design hierarchically while understanding the whole flow and where the parts fit in it.

### Options

Options represent branching based on tests of signal values in a state machine. In the source code 102, state machine decision points are represented using options in a node, e.g., as follows:

nodea:

(a==1), path1

<> (a!=1), path2
<> (a==3), path3

At the point where nodea is used in a sequence, the value of ‘a’ determines on which of the paths execution will continue in future clock cycles. The output code 112 comes out as follows:

fsm = SC_ERROR;
if (a == 1) {

fsm = S1;

}
if (a != 1) {

fsm = S5;

}
if (a == 3) {

fsm = S9

}

where S1 is the state that starts path1, S5 is the state that starts path2 and S9 is the state that starts path3. Since these are individual if statements, they are not necessarily mutually exclusive. Note, e.g., that (a!=1) and (a==3) may both be true. In this case, since (a==3) comes last, if ‘a’ does equal 3 the machine will go to state S9 even though the test (a!=1) is also true. Note also that in a preferred embodiment even though at least one of these tests has to evaluate to true, a default transition to SC_ERROR is still generated. This is because for arbitrarily complex tests, it can not be determine if the tests cover all possibilities. Thus in case none of the tests are true, the generated code 112 provides for the state machine to go to the defined SC_ERROR (default S0).

Optionally, the designer may employ a continue statement in the source code 102 to avoid error conditions which may occur when none of the tests in a series are passed. If the first option is a continue statement, then it is known to simply continue on if none of the tests in a series of options passes. This also tells a reader of the source code 102 that the designer thought about what should happen if none of the possible paths are invoked and the designer decided that the machine should just go on. An exemplary use of the continue statement in the code 102 is:

nodea:

continue

<> (a==1), path1
<> (a!=1), path2
<> (a==3), path3
;

Preferably, the first clock cycle always executes for all options. When a list of options in the source code 102 is translated into output code 112 by the compiler, a series of if statements are created. If the tests for the options are put in curly braces, and if there is some code inside those curly braces with the test, that code will execute if the test is true independently of the truth of any other option test. In other words, this means that if the source code 102 is given as:

nodea:

{(a==1), line1=d}, path1

<>{(a!=1), line2=d}, path2
<> {(a==3), line3=d}, path3
;

then the output code 112 will be:

if(a == 1) {

fsm = S1;
line1 = d;

}
if(a != 1) {

fsm = S5;
line2 = d;

}
if (a == 3) {

fsm = S9;
line3 = d;

}

where the fsm assignment is overridden, but the line assignment is not. For example, if ‘a’ is equal to 3, then line2 and line3 will be assigned the value of d, and after that, the machine will proceed to start down path3 at S9. This capability can be used to advantage, but can also be a source of error.

In accordance with a preferred embodiment of the present invention, an option without a test will always execute. If the first option in a list of options in a node has no test associated with it, there are two ramifications. One, the first option will always execute, though if it's an assignment, it may be overridden. Two, if none of the tests in any of the other options pass, the next state the machine goes to will be the one which follows this first option. For example, if the source code 102 is given as:

nodea:

d=1, ...

<>{(a==1), d=0}, ...
<>{a==3), d=2}, ...
;

then the created output code 112 will be as follows:

fsm = S1;
d = 1;
if (a == 1) {

fsm = S5;
d = 0;

}
if (a == 3) {

fsm = S9;
d = 2;

}

This technique allows a designer to always do something (or many things if the curly braces are used) at the beginning of a node, and do other things and choose a path based on the tests in the other options.

If one of the option tests in a sequence of options in a node is a ‘wait’, then the default transition is to stay in the same state. That is, the machine waits for that condition or any of the other conditions to become true. For example, the source code 102:

nodea:

{(a==1), d=0}, ...

<>{wait(a==3), d=2}, ...
;

will produce the output code 112:

if (a == 1) {

fsm = S5;
d = 0;

}
if (a == 3) {

fsm = S9;
d = 2;

}

Note that a transition to another state will only occur if one of the tests passes. Note also that it doesn't actually matter, in this case, which of the tests is made a wait. If wait is used with an integer number such as wait(64) instead of a wait(test), then it acts like a timeout. See the timeout part of the Wait section below for more information on how to code timeouts.

### Sequence of Items

The sequence of items is where the “work” is done. In accordance with a preferred embodiment of the present invention, an item may be one of any of the following types:

an assignment, e.g., dout=data[0];

a test, e.g., (sync==1);

a concurrent item, e.g., {(sync==1), dout=data[0], bits_sent++}; or,

a node reference, e.g., fill_buffer.

Each item is separated from the next by a defined delimiter (preferably, and as used herein, a comma ‘,’) which represents a clock cycle based on the clock specified in the START node statement. In the simplest terms, each item can be imagined as a state in the eventual machine with the fsm changing its state each clock cycle. It doesn't necessarily turn out that way, but the description is figuratively correct.

Assignments and tests are essentially the same as those used in conventional high level C-based programming. All the usual assignment operators (e.g., ‘+=’, ‘<<=’, etc.) are supported, and any expression typically used in an if statement test can also be used in the source code 102.

With respect to concurrent items, normally, when two items are shown, one after the other in a sequence, they each take up a clock cycle. When a designer wishes a series of items to occur in the same clock cycle, or at the same time, they are put in curly braces. For example, {parity \hat{ }=data[0], dout=data[0], bits_sent++} will put all three of the items in the same state and they will be active in the machine at the same time. See the following sections on Tests in a Sequence and If-Then-Else for more on how tests inside these curly braces affect execution.

An item can also be a reference to another node. This makes a sequence easier to read and breaks the description down hierarchically. In the example {dout=data[0], do_parity, bits_sent++}, “do parity” is a reference to another node. That is, “bits_sent++” is not a node. Note that the contents of nodes referenced inside curly braces will be expanded in the same concurrent time as the rest of the items in the curly braces. For example, the source code 102:

{

dout = data[0],
do_parity,
bits_sent++

}

will produce the output code 112:

fsm=next_state_in_machine;

dout=data[0];

parity \hat{ }=dout;

bits_sent++;

With respect to nodes with options referenced inside curly braces, if the node referenced inside curly braces has options in it, then the result is the same as if each option was scoped with an inside set of curly braces. This means, e.g., if nodes a and b in the source code 102 are as follows:

nodea:
{

dout = data[0],
nodeb,
bits_sent++

}
nodeb:

cs=FLOAT

<>(a[1:0] == 1), cs=0
<>(a[1:0] == 3), cs=1
;

then the resulting code 112 will look like:

fsm = next_state_in_machine;
dout = data[0];
cs = FLOAT;
if (a[1:0] == 1) {

cs=0;

}
if (a[1:0] == 3) {

cs=1;

}
bits_sent++;

Since all the code inside a set of curly braces is executed in the clock cycle, the contents of nodeb is executed inside one clock cycle as well.

If nodeb is used from another sequence which is not inside curly braces, the tests will be compiled as branches (true options) and the setting of ‘cs’ will be in the next clock cycle. For example, the output code 112 then looks like:

fsm = next_state_in_machine;
cs = FLOAT;
if (a[1:0] == 1) {

fsm = S5;

}
if (a[1:0] == 3) {

fsm = S12;

}

where S5 is the state where ‘cs’ is set to 0, and S12 is the state where ‘cs’ is set to 1. A node may be used in either way or both ways in a specification file 102.

### Tests in a Sequence

A test in a sequence is a decision point. It determines if the rest of the sequence is to be executed. Tests may be used in a sequence in the following ways:

tests in a regular sequence;

tests inside curly braces; or,

tests inside curly braces which are inside curly braces.

Regarding tests in a regular sequence, a regular sequence (one not inside curly braces) may have a test embedded in it, such as for example:

d=0, (error==0), d=1

In the source code 102, this means it is expected that error is equal to 0 at the time of the test. If error is set (i.e., equal to 1), it is not clear exactly what the machine is to do. In this case, the machine will go to the SC_ERROR state (defaulting to the initial state of the machine). This technique, while viable, is not necessarily recommended. Rather, for clarity tests are preferably used at the beginning of options to purposefully define alternative execution of sequences. These tests preferably cover all possible options or provide a continue or wait to avoid “accidental” transition to the initial state. That is, e.g., the following source code 102:

nodea:

d=0, nodeb

;

nodeb:

(error==0), d=1

<> (error==1), . . .
;

shows exactly what a designer wants to happen if error equals one. If a test is included in a sequence, and an alternative sequence to execute is not provided for if the test fails, the compiler will generate in the output code 112 a transition to the initial state of the machine (or other state if SC_ERROR has been defined as some other state). This is because the state machine must go somewhere and it is viewed as an error if a test which is in a regular sequence fails. Preferably, a designer can look at the generated code 112 and see if they have any SC_ERROR transitions. While some are fine and expected and cannot ever actually happen, others may indicate an incomplete protocol specification.

Regarding tests inside curly braces, a test which occurs as the first item inside a set of curly braces is treated the same way as a test in a regular sequence, but it also controls execution of the rest of the items in the curly braces for the clock cycle. For example, consider the source code 102:

d=0, {(error==0), d=1}, d=0

Again, this means error is expected to be equal to 0. If error is set (i.e., equal to 1), it is not clear what exactly the machine is wanted to do. In this case, the machine will go to the SC_ERROR state (defaulting to the initial state of the machine). If the test is not the first item inside the curly braces, then it only affects the execution of the rest of the items inside the curly braces. Consider, e.g., the source code 102:

d=0, {d=0, (error==0), d=1}, d=0

Here, in the second clock cycle, d will be assigned a 0, then if error is 0, that is overridden and d is assigned a 1. Then the next clock cycle will assign d=0 whether error was set to 0 or 1. Note that you can make a test not the first thing inside the curly braces by inserting in a continue at the beginning, e.g., as follows:

d=0, {continue, (error==0), d=1}, d=0

Tests in a concurrent sequence are cumulative. Since the rest of the items in the curly braces are executed only if that test passes, another test, further along in the sequence will only be executed if the first test passes as well. That is, future tests are really an ‘and’ of all tests that occurred before it. So in this source code 102, for example:

d=0, {d=0, (error1), d=1, (error2), d1=0}, done=1

the code in the curly braces will produce output code 112:

fsm = next_state_in_machine;
d=0;
if (error1) {

d=1;
if (error2) {

d1 = 0;

}

}

This means that inside the curly braces, d is set to 0, then, if error1 is set, d's value is overridden to 1. Then d1=0 is executed only if both error1 and error2 are set.

Regarding tests inside curly braces which are inside curly braces, curly braces can be nested to define the scope of tests that are within these braces. In the following exemplary source code 102 segment:

d=0, {d=0, {(error1), d=1}, (error2), d1=0}, done=1

the code inside the curly braces produces the output code 112:

fsm = next_state_in_machine;
d=0;
if (error1) {

d=1;

}
if (error2) {

d1 = 0;

}

By adding the extra set of curly braces, the test for error1 is scoped to only the assignment of d. The next part of the sequence “(error2), d1=0” is now separated from the test for error1. This allows a designer to create if-then-else sequences inside one clock cycle by using mutually exclusive tests and interior curly braces. Note, in the last example, that curly braces were not put around the error2 test and the associated assignment. This is because the test is already scoped by the terminating outside curly brace.

If-Then-Else

There are two forms of if-then-else constructs in accordance with a preferred embodiment of the present invention. One involves using options in a node, and the other involves conditional execution inside curly braces, ‘{’ and ‘}’.

Note that in regular use, options in a node are listed in priority order, and the first clock cycle of each option is executed at the beginning of the execution of the node. Thus options in a list of options are really separate if statements, each independent of the others. Using options to form if-then-else constructs involves the formation of mutually exclusive tests. For example the source code 102:

node:

{(a==0), send_byte=1} . . .

<> {(a!=0), send_nibble=1} . . .
;

results in output code 112:

fsm = next_state_in_machine
if (a == 0) {

send_byte = 1;

}
if (a != 0) {

send_nibble = 1;

}

which is an if-then-else result. However, the following source code 102 segment will not yield an if-then-else result:

node:

{(a==0), send_word=1}, . . .

<> {(a!=0), send_byte=1}, . . .
<> {(a==3), send_nibble=1}, . . .
;

because send_byte and send_nibble could both be set to one since three independent if statements are generated.

There are two ways to produce if-then-else constructs using options. One is to use mutually exclusive tests as described. The other is to do only the test in the first clock cycle and thus never do two of the actual operations, for example:

node:

(a==0), send_word=1, . . .

<> (a!=0), send_byte=1, . . .
<> (a==3), send_nibble=1, . . .
;

Since the first clock cycle in this node will only test the value of a, the three send possibilities are now mutually exclusive, but will be set a clock cycle later than in the previous examples because there are no curly braces.

Regarding if-then-else constructs inside curly braces, a test inside curly braces affects the rest of the sequence unless the test and some subset of the rest of the sequence is inside another set curly braces. That is, for example:

d=0, {d=0, (error1), d=1, (error2), d1=0}, done=1

says that d1=0 will only be executed if both error1 and error2 are true. However, if another set of curly braces are used inside this set, such as:

d=0, {d=0, {(error1), d=1}, (error2), d1=0}, done=1

then the test for error2 is independent of the now scoped test for error1. So, if the tests are made mutually exclusive as in the source code 102 which follows:

d=0, {d=0, {(error1 && !error2), d=0}, (error2 && !error1), d1=0}, done=1

then an if-then-else construct results in the output code 112 as follows:

node_fsm = S2;
d = 0;
if (error1 && !error2) {

d = 0;

}
if (error2 && !error1) {

d1 = 0;

}

It is to be remembered that hardware is concurrent which has the affect of making the last instruction where an assignment of a signal occurs, the only one that matters, thus, for example the source code 102:

{d=1, (out==0), d=FLOAT}

results in an output code 112 where d will be set to 1, but if out is 0, then that assignment is overridden to set d equal to float. That output code 112 is, for example, given as:

fsm = next_state_in_machine;
d = 1;
if (out == 0) {

d = FLOAT;

}

When the ‘then’ and the ‘else’ parts of the construct set the same signals, the if-then-else construct becomes a set-if-then-set_differently construct where the else comes first then the if-then comes after. This also works for the option technique. Consider the source code 102:

node1:

d=1

<> { (out==0), d = FLOAT}
;

This results in the same output code 112 as generated for the previous example.

Waiting

In accordance with a preferred embodiment of the present invention, a designer is provided with the ability to wait for a number of clock cycles, or until an event occurs in several ways. Those ways include:

waiting a constant number of clock cycles;

waiting for an event;

doing something while waiting for an event;

a special use of wait for timeout implementation; and

a special use of wait as ‘continue’.

The “wait” function is used to hold a machine in its current state until some time goes by or until an expression is true. There is some overlap between using wait and using ‘#’ to repeat a sequence. See the section on Repeating Sequences below for more detail.

If, in a sequence, a designer wants to pause a machine for a number of clock cycles, for instance if he wants to wait 4 clock cycles for an address to propagate before looking at the data, he would use the source code 102:

wait(4)

which will result in output code 112 such as, for example:

Xcounter_1++;
if (Xcounter_1 >= 3) {

fsm = next_state_in_machine;
Xcounter_1 = 0;

}

When not in this loop, the Xcounter will have the value 0. The generated declaration will make the STATE initialize to 0 and it is always reset to 0.

In a sequence, a machine can also be paused until an expression becomes true. For instance, if it is desired to wait for the signal ‘ack’ to be set, a designer may, e.g., employ the source code 102:

wait(ack)

which results in output code 112:

if (ack) {

fsm = next_state_in_machine;

}

There is the option of continuing to do a sequence of items while waiting. For instance if it is desired to wait for the signal ‘ack’ to be set while continuing to apply address use the { } construct in the source code 102 as follows:

{address=addr, wait(ack)}

which results in output code 112:

address = addr;
if (ack) {

fsm = next_state_in_machine;

}

It is also possible to add items after the wait that will execute in the same clock cycle but only if the condition is true. For instance, the source code 102:

{address=addr, wait(ack), data=d}

results in output code 112:

address = addr;
if (ack) {

fsm = next_state_in_machine;
data = d;

}

Preferably, a designer also has the option of implementing timeouts for an operation using a wait. This allows the designer to wait for either a condition to become true or until a number of clocks have gone by, whichever happens first. For example, to wait for an ack, but timeout if the operation takes longer than 64 clock cycles, the source code 102 may look like:

readdata:

(ack), d = data

<> wait(64), ...
;

which translates to output code 112 that looks like:

Xcounter_1++;
if (ack == 1){

fsm = S1;
Xcounter_1 = 0;

}
if (Xcounter_1 >= 63) {

fsm = S6;
Xcounter_1 = 0;

}

Thus, if ack goes to 1, the state machine will move on to the state where d is set to data (here S1) and if the timer counts from 0 to 63, then the machine will move on to the state that comes after the timeout (here S6) without doing the actual data transfer.

In place of ‘wait(1)’ in the source code 102, which would wait one clock cycle then go on, ‘continue’ can also be used. It tends to be more readable and means simply that a clock cycle is used up. Continue is usually used as a do nothing option in a list. That is, if a designer wants to choose from three possible options, but wants to do nothing if none of the option tests are true, then the designer can use a continue to say “none of the above” or actually, below. For example, the source code 102:

node:

continue

<> (a==1), ...
<> (a==3), ...

;

results in output code 112:

fsm = S3;
if(a==1){

fsm = S4;

}
if (a==3) {

fsm = S6

}

Thus if ‘a’ is 1, the machine goes on down that path. If ‘a’ is 3 the machine goes down the path that comes after that test. But if ‘a’ is neither 1 nor 3, then the machine goes to whatever state came after the evocation of node in the protocol description, here S3. Leaving the continue out would have changed the resulting machine by making it an error condition if ‘a’ was not 1 or 3. Thus the resulting output code 112 would have been:

fsm = SC_ERROR;
if(a==1){

fsm = S4;

}
if (a==3) {

fsm = S6

}

where if ‘a’ were neither 1 nor 3, the state machine would proceed to state 0 (unless SC_ERROR was specified to be something else).

### Repeating a Sequence

The present inventive programming language allows a designer to repeat a sequence of items in five primary ways, namely:

a constant number of times;

a variable number of times;

until a condition is true;

forever; or,

using a specified counter (for loop style).

Preferably, and as used herein, a ‘#’ symbol after a sequence identifies the sequence as repeated. However, another defined symbol may be used.

If a single statement is followed by a ‘#’, that statement is repeated. If the ‘#’ comes after a ‘}’, the clock cycle represented by the contents of the curly braces is repeated. If a node item is followed by a ‘#’, then the whole sequence represented by the node will be repeated. If a node is repeated, then the test to see if the loop is complete will be done in the last state of the node's sequence to decide whether to go back to the beginning of the sequence again, or move on in the state machine.

To repeat a sequence a constant number of times, an integer representative of the number of repeats follows the ‘#’. See, e.g., the following source code 102 for three different repeats:

node_name#3
{a=0, d[5] = 1}#27
d=1#4

When compiled, a counter is generated to count from 0 to the provided number−1. The counter is declared and has the name Xcounter_z, where z is a number which distinguishes this counter from other counters. The counter is tested in the last clock cycle of the sequence. If the counter is equal to the number of repetitions requested−1, then the state machine moves on to the next item. Thus the resulting hardware would look the same as if the sequence had actually been typed in that many times (i.e., d=3#2 would be the same as typing d=3, d=3). By way of example, given the source code 102:

d=3#5

the following output code 112 would result after compiling:

d = 3;
Xcounter_0++;
if (Xcounter_0 >= 4) {

fsm = next_state_in_machine;
Xcounter_0 = 0;

}

When not in this loop, the Xcounter will have the value 0. The declaration will make the STATE initialize to 0 and it is always reset to 0.

In the source code 102, a designer can provide a vector to make a sequence repeat that many times. The following three examples of source code 102 employ the vectors ‘cnt’, ‘num’ and ‘how_many’:

node_name#cnt
{a=0, d[5] = 1}#num
d=1#how_many

When compiled, a counter is generated to count from 0 to the provided vector value−1. The counter is declared and has the name Xcounter_z where z is a number which distinguishes this counter from other counters. The counter is tested in the last clock cycle of the sequence. If the counter is equal to the value in the vector−1, then the state machine moves on to the next item. Note that if the value in the vector changes during the execution of the repeated sequence, then the compare will be done against the new value. By way of example, the source code 102:

d=3#count

results in output code 112:

d = 3;
Xcounter_0++;
if (Xcounter_0 >= count − 1) {

fsm = next_state_in_machine;
Xcounter_0 = 0;

}

Note that since it is checking against count−1 here, if count is 0 it will actually check against all ones, which may not be what is wanted. To avoid this, use another option or a test to have this loop only execute if count is not 0. Again, when not in this loop, the Xcounter will have the value 0. The declaration will make the STATE initialize to 0 and it is always reset to 0. Note also that repeated sequences will execute at least once. To avoid this, it is advisable to have an alternative specified at the beginning of the loop. For more on this, see the section on Ways to Leave a Repeating Sequence.

It also possible to provide an expression whereby a sequence is repeated until that expression evaluates to true. Three examples of such source code 102 are:

node_name#(found==1)
{a=0, d[5] = 1}#(number_checked == 0)
d=1#(send)

The test is generated in the last clock cycle of the sequence, and if the test evaluates to true, then the state machine moves on to the next item. For example, the source code 102:

d=3#(number_checked==0)

translated to the output code 112:

d = 3;
if (number_checked == 0) {

fsm = next_state_in_machine;

}

If the ‘#’ is used by itself, the sequence will be repeated until some outside operation changes the state of the state machine. Thus the last state of the repeated sequence will have a goto back to the first. This construct is usually used with the ‘!!’ or interrupt operation. The exemplary source code 102:

d=1#!!(send_data==1)

results in output code 112:

d=1;

along with an interrupt segment of code at the bottom of the state machine which will set the fsm to the next state if the machine is in this state and send_data==1. See the below section Interrupting a Sequence for more on how interrupt codes work.

It is also possible to provide the counter name to be used in the output code 112 and thus have the counter available in the sequence code. This structure also allows a designer to specify the start, the finish and the step size for the counter. Exemplary source code 102 looks like:

node_name#my counter TO 4

{a=0, d[my_counter]=1}#my_counter FROM 3 TO 9 BY 3

node_name#address FROM 0x0000ffff TO top BY word_size

FROM defaults to 0

BY defaults to 1

Note that if specifying a counter by name, it should be declared just like any other STATE. Also, it is preferred that automatically created counters (Xcounter_z) used in a file are reused in the resulting VHDL as much as possible, thus saving flip-flops in the design. See the section on State Machine Optimizations. In a preferred embodiment, counters declared and specified by the designer cannot be combined with other counters, so named counters should be used only when the counter's value will be employed inside of the repeated sequence. Also, for a particular named counter, all uses of the counter in repeated sequences start at the same constant value. The TO and BY options may be specified with expressions, but the FROM is an integer. By way of example, the source code 102:

d=data[count]#count FROM 1 TO top BY 3

results in output code 112:

d = data[count];
count = count + 3;
if (count > (top − 3)) {

fsm = next_state_in_machine;
count = 1;

}

When not in this loop, count will have the value 1. The declaration will be changed to make the STATE initialize to 1 and it is always reset to 1 when the loop completes. While a designer can change the initial value of the counter by setting it elsewhere in the source code 102, this is not a good design strategy.

### Interrupting a Sequence

In accordance with a preferred embodiment of the present invention, a sequence can be interrupted by using the !! operator with a test which, when true, will break the execution of the sequence and move the state machine to the state after the interrupted sequence. Activation signals (Xactiv_z where z is a number distinguishing one activation signal from another) are used to implement interrupts. These STATE signals are set to 1 when the machine is in a section of code which is interruptible.

For example, if the source code 102 included:

nodel 1!!(int)

then before node1 is entered, the activation signal for this interrupt will be set to 1 and in the last state of node1, the activation signal is set back to 0. Added at the bottom of the generated machine will be the following section of output code 112:

if ( (int) && (Xactive_0) ) {

fsm = next_state_in_machine;
Xactive_0 = 0;

}

This effectively stops execution of nodel and proceeds on in the machine. Thus the source code 102:

wait(ack)!!(sync)

would be the same as the source code 102:

wait(ack∥ sync)

but less efficient because it uses the activation signal flip-flop.

In any event, the interrupt is usually used to break out of a repeated sequence. This combines the use of ‘#’ and ‘!!’. By way of example, the source code 102:

timeslot#256!!(sync==1)

will result in the same source code 102 as:

timeslot#256

except for two differences. First, an activation signal would be set to one on entry into timeslot and set to zero on exit from timeslot. Second, at the bottom of the machine, the output code 112 would also have:

if ( (sync == 1) && (Xactive_0) ) {

fsm = next_state_in_machine;
Xactive_0 = 0;

}

Continuously repeating sequences can also be interrupted in the same way. For example, the following source code 102:

send_idle#!!(send_byte==1)

achieves this goal.

### Ways to Leave A Repeating Sequence

Three ways to conditionally leave a repeating sequence include:

using a test at the end (i.e., do until);

using a test at the beginning (i.e., do while); and,

using a test at any point in the sequence (i.e., do as long as).

These techniques are described in more detail in other sections herein, but this section gives an overview of how to leave a repeating sequence.

If it is desired to conditionally leave a repeating sequence using a test at the end of a sequence, source code 102 like the following is used:

node1#(by_pass==1)

which results in a test (i.e., by_pass 1) in the last state of nodel to determine if execution should go back to the beginning of the sequence or continue on to the next sequence after node1.

If it is desired to conditionally leave a repeating sequence using a test at the beginning of a sequence, source code 102 like the following is used:

NODE:

node1#

<> (by_pass == 1)
;

which results in a test (i.e., by₁₃ pass==1) in the first state of nodel to determine if execution should proceed in node1, or continue to whatever comes after NODE in the protocol. Note that the test for by_pass has a higher priority than the execution of nodel, so if by_pass is 1, then only the first clock cycle of node1 is executed.

If it is desired to conditionally leave a sequence at any time during the execution of the sequence, source code 102 like the following, employing the interrupt capability, is used:

node1#!!(by_pass==1)

The ‘#’ will put a goto at the end of the node1 sequence to go back to the beginning of node1 and the ‘!!’ will place interrupt code at the bottom of the machine which will move the machine to the next state after nodel if by pass is 1.

### Enable

In accordance with a preferred embodiment of the present invention, individual state machines may be turned on and off based on a test. This is done using the ENABLE keyword in the source code 102 for the start node definition, such as:

START ENABLE (test)

node_name:

For example, if a designer desires the machine uart to run only when uart_en is set to 1, the following source code 102 may be used:

START ENABLE (uart_en == 1)
uart:

idle

<> {(send), start_bit}, data_byte, parity_bit, stop_bit
;

which would result in the code for the whole uart machine being wrapped in an if statement in the output code 112 as follows:

if (uart_en == 1 ){

uart machine

}

Note that this means the machine stops when uart_en does not equal 1 and then picks up exactly where it left off when uart_en again equals 1. This is not a reset. For a reset, a designer uses the ‘!!’ structure shown in the interrupt section.

### Compressed Notation

In the interest of keeping the source code 102 description short, but clear and readable, a limited compression notation is included for indices in statements and expressions. There are preferably two types:

counting, using the ‘->’ operator; and,

listing using the ‘,’ operator.

Of course, alternate notations or characters may be used for the operators.

If it is desired to do something repeatedly, but with a sequential index, a compressed notation can be used with the ‘->’ operator. For example, the source code 102:

d=data[0], d=data[1], d=data[2], d=data[3], d=data[4]

can be written in the compressed notation:

d=data[0->4]

This works for expressions too. For example, the source code 102:

(d==data[0]), (d==data[1]), (d==data[2]), (d==data[3]), (d==data[4])

can be written as:

d==data[0->4]

If compressed notation is used inside a concurrent sequence, that is, inside curly braces, then the whole concurrent sequence will be included in the repeated sequence. Thus,

{d=data[0->7], par \hat{ }d}

will yield

{d=data[0], par \hat{ }=d},

{d=data[1], par \hat{ }=d},

{d=data[2], par \hat{ }=d},

{d=data[3], par \hat{ }=d},

{d=data[4], par \hat{ }=d},

{d=data[5], par \hat{ }=d},

{d=data[6], par \hat{ }=d},

{d=data[7], par \hat{ }=d}.

If the desired indices are not in order, that is, so the first and last indices cannot just be shown with an assumed increment of one, then a list of the desired indices can be made inside the brackets with each being separated by commas. For example:

{d=data[0,4,7], par \hat{ }=d}

translates to:

1{d=data[0], par \hat{ }=d},

{d=data[4], par \hat{ }=d},

{d=data[7], par \hat{ }=d},

### The Defaults Block

In many protocol definitions, it may be desired to set defaults for signals or calculation results which may or may not be overridden in the actual machines defined in the rest of the file 102. If a machine is defined that only has one state, then the compiler knows not to build the state machine infrastructure around it. To generate these default values, a start state (which may be called anything, but it is advantageous to use ‘defaults’ to make the intent obvious) may be used and all the default assignments put in that node and inside the curly braces, ‘{‘ ’}’, or concurrency indicators. An example of a default block in the source code 102 may look like:

START
defaults:

{

d = 1,
address = send_count<<2,
direction = (dir == net)

}

;

By putting this node first in the file 102, the assignments can be overridden in the rest of the machines. Note that since the output code 112 generated from the source code 102 is a high level C-base code or pseudo-code, all SIGNALs, OUTPUTs, COUTPUTs and POUTPUTs will default to 0, so it is not necessary to put those defaults in a default block. If it is desired that they default to 1 (e.g., as in active low signals), a default block can be used to accomplish that.

The output code 112 generated from the preceding source code 102 is:

/* No state machine required for defaults_fsm protocol. */

d=1;

address=send_{—count <<}2;

direction=(dir==net);

Preferably, the comment will come out too, showing a reader of the output code 112 that this is a one-state state machine.

### The Always Block

In many protocol definitions, it may be desired to set signals or calculate results during every clock cycle for use in various places in the main machines or to continuously generate outputs. Again, if a machine is defined that only has one state, then the compiler knows not to build the state machine infrastructure around it. Thus to generate these values every clock cycle, a start state (which may be called anything, but it is advantageous to use ‘always’ to make the intent obvious) may be used and all the assignments put in that node and inside the curly braces, ‘{‘ ’}’, or concurrency indicators. An example of an always block in the source code 102 may look like:

START
always:

{

address = send_count<<2,
error = (par_err || crc_err || overflow_err),
dout = FLOAT,
(out_en),
dout = d

}

;

which results in the following output code 112:

/* No state machine required for defaults_fsm protocol. */
address = send_count << 2;
error = (par_err || crc_err || overflow_err);
dout = FLOAT;
if (out_en == 1 ) {
dout = d;
}

Again, preferably, the comment will come out too, showing a reader of the output code 112 that this is a one-state state machine. Always blocks are usually put at the end of a file 102 of machines to make sure none of the assignments can be overridden anywhere else in the model.

### State Machine Optimizations

In accordance with a preferred embodiment of the present invention, optimization in the resulting state machine is achieved in a number of ways. They include:

turning repeated sequences into one sequence and a counter;

reusing generated counters; and,

reusing states.

During compilation, sequences of states are identified that occur more than twice in a row. They are collapsed into one state and a counter is wrapped around the execution of that sequence. The sequence may be one state that occurs many times in a row, or it may be a sequence of many states which is repeated. This reduces the amount of output code 112 and the number of states and allows for reuse of the generated counters.

Counters are generated when ever a ‘#’ is used in the source code 102 with a number or vector after it. Counters are also generated when repeated sequences are found that can be collapsed. These counters are named Xcounter_z, where the z is a number which distinguishes one counter from another. Since these counters are used in predictable ways and their scope of use can be determined, a smaller counter can be removed and replaced by a larger one when the scope of the smaller counter is completely outside the scope of the larger counter. So, while initially there may be, e.g., ten counters created for various functions, it may actually only use, e.g., two counters to cover the functions required.

Sometimes the assignment for state machine states is ‘one hot.’ This means there is a vector that defines which state the machine is in, and there is one bit in the vector for each state. That is, one signal is hot to define a state. This also means that for each state added to the machine, a flip-flop is added to this vector. Thus, when a repeated sequence of states is collapsed by the compiler into one sequence with a counter, many flip-flops may be saved. Additionally, since counters are combined where possible, the counter added for a repeated sequence may not affect the flip-flop count at all. It is also noteworthy that many synthesis programs allow a designer to not use one hot encoding should it be preferred to trade speed for flip-flops.

In accordance with a preferred embodiment of the present invention, situations are also identified where states are the same, and they are combined into one state. Two states are deemed the same when they have the same output code 112, go to the same state upon completion, and are in the same context in terms of activation signals.

### Node Tracking for Simulation

In a preferred embodiment, the present invention also allows a designer to keep track of the nodes that are active during a simulation in a simulation wave window. Node tracking is inserted into the generated machine using the ‘-n’ option on the command line entered to compile the source code file 102. This is a valuable debugging tool during simulation and it allows a designer to more easily line up simulation results with the corresponding source code 102.

When using the ‘-n’ option, variables are put in the output code 112 which have the same names as the node names in the source code 102. These node variables are set in every state that has been generated from that node. This allows a designer to see what node is being executed as the simulation runs. If the state generated is three levels deep in the hierarchy of nodes, then three of these node variables will be set during that state, one for each node in the hierarchy.

At times there may be two or more of the node variables set to undefined. When the compiler combines repeated state sequences with a counter, or equivalent states into one state, the resulting state or states may be executed from multiple paths (that is, they may be part of different nodes). Since there is no way of knowing which of the paths brought execution to this point, the node tracking generates an ‘undefined’ for each node in question. The information is still important because, usually, the designer knows by context which of the two paths is being executed and he really just needs to know when the node execution started and when it finished.

### Reversing Protocols

In accordance with a preferred embodiment of the present invention, some source code 102 descriptions may be reversed. This means that from the same interface protocol description in a source code file 102, output code 112 for both the transmit and the receive versions of the machine can be selectively generated such that if the inputs and outputs of the transmit side were tied to the outputs and inputs of the receive side, respectively, the two could talk to each other. The outside interface on the receive side would be the reciprocal of the outside interface on the transmit side.

Signals declared as SOUTPUTs, COUTPUTs, POUTPUTs, SIGNALs, or STATEs will be used the same way in the receive side state machine. Signals declared as OUTPUT or INPUT will be reversed. That is INPUTs will become COUTPUTs and OUTPUTs will become INPUTs. Signals which need to be inputs on both sides of the protocol are declared as EXTERN.

The reversed machine will convert assignments to OUTPUTs on the transmit side to tests against INPUTs on the receive side and tests against INPUTs on the transmit side to assignments to OUTPUTs on the receive side. Some assignments will be moved forward in the grammar and there may be other changes to facilitate generation of the receive side.

### Embedding Output Code in the Source Code File

In accordance with a preferred embodiment of the present invention, output code is able to be embedded in the source code file 102. This is useful, e.g., at times when it is desired to include lines of code understandable in the output code language but that are not valid source code. For example:

C-based functions for calculating certain values;

C-based command line options; and/or,

C-based code included from other files.

This is accommodated by using ‘%%’ as the first characters on a line, so that all the characters up to the next occurrence of ‘%%’ as the first two characters will be passed directly on to the output file 112 without any other action being taken on them.

For example:

%%spr2vhd -reset_async_high -n rst
// crc_update - calculates next state of CRC
SIGNAL*
crc_update(crc_current[], bit, poly[]) {

VARIABLE crc_nxt[crc_current.length];
VARIABLE feed;
// feedback from last bit in register XOR'd with input bit
feed = crc_current[crc_current.left] \hat{ } bit;
crc_nxt = (crc_current << 1 ) \hat{ } ((feed)? poly : 0 );
return (crc_nxt);

}
#include “readReg.C”
INPUT rst; // General reset;
%%
START RCLK clk ENABLE trans_en
trans:
etc...

Note that ‘%%’ sections preferably occur only at the start and the end of the file. Code from one at the start will be placed at the beginning of the output file 112. The section at the end will be inserted at the end of the resulting file 112, but before the final end curly brace for the main procedure for the output file 112. Preferably, a ‘%%’ section is not placed at any other location in the source code file 102.

Output code functions are also included as shown in the example above. They are preferably included either in a ‘#include’ file or specified in line between occurrences of ‘%%’ so the compiler doesn't think it is source code.

Command line options in the output code language can also be included in the resulting file 112 as shown in the example above. Note that the options are preferably on the same line as the first ‘%%’ if in the output file 112, this line must be the very first line.

Included files also work as shown in the above example. A designer may use ‘#include’ or the like as he would in other C-based programming. Remember that output code constructs work between occurrences of ‘%%’. If the include line is put inside the ‘%%’s at the bottom, the ‘#include’ will be inserted before the ending curly brace of the main procedure.

### Command Line

As stated already, the present invention generates state machines in the output code 112 from a higher level specification of the grammar for the machines in the source code 102. The compiling of the output code file 112 from the source code file 112 is initiated by entering a command on a command line, or other like action. In a preferred embodiment, the command line entry allows a designer to exercise a number of options. The ‘-t’ option generates the transmit version of the output of the output file 112. The ‘-r’ option generates the receive version of the machine. This is used when a designer want generate the reverse side of a protocol converter. The ‘-o’ option is used to override the standard filename for the generated file 112. The ‘-n’ option inserts node variables in the resulting output code 112. The ‘-d’ option generates debugging information which is dumped to a file which is useful to the designer. Using the command without any arguments, or with illegal arguments or with a ‘-?’ option preferably generates a usage message.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method of designing hardware, said method comprising:
(a) entering source code into a source code file, said source code using a context-free grammar that describes a job the hardware being designed has to do rather than describing an implementation of the hardware; and,
(b) compiling the source code file to generate an output file which describes an optimized state machine for implementing the hardware, said output file being written in a C-based code.

2. The method according to claim 1, wherein from the same source code file, output files can be generated in step (b) which describe both transmit and receive state machines.

3. The method according to claim 1, further comprising:
(c) converting the output file to at least one of a hardware description language and a register transfer level code.

4. The method according to claim 1, wherein optimization of the state machine is achieved by:
identifying sequences of states in the source code file that occur more than twice in a row;
collapsing the identified sequence into one state in the output file; and,
wrapping a counter around the one state.

5. The method according to claim 1, wherein a BNF style notation is used to create the source code.

6. Residing on a computer-readable medium, computer software for designing hardware, said software comprising:
a compiler which generates from source code an output file that describes an optimized state machine for implementing hardware, said source code using a context-free grammar that describes a job that the hardware being designed has to do, and said output file being written in a C-based language.

7. The software according to claim 6, wherein from the same source code, the compiler can generate output files which describe both transmit and receive state machines.

8. The software according to claim 6, wherein optimization of the state machine is achieved by the compiler identifying sequences of states in the source code that occur two or more times in a row; collapsing the identified sequence in the output file such that the sequence occurs only once; and, wrapping a counter around the collapsed sequence.

9. The software according to claim 6, wherein said software further comprises:
a node tracking option such that when a user selects the node tracking option, the compiler puts variables in the output file which have names matching those of corresponding nodes in the source code, said variables getting set to a defined value in every state that is generated from its corresponding node.

10. A system for designing hardware, said system comprising:
a computer having means for entering an input file written in a source code, said source code using a context-free grammar which describes a job that hardware being designed has to do; and,
a compiler which runs on the computer, said compiler selective converting the input file into an output file which is written in a C-based code, said output file describing an optimized state machine for implementing the hardware being designed.

11. The system according to claim 10, wherein the system further comprises:
means for translating the output file from the C-based code to a hardware description language.

12. The system according to claim 11, wherein the hardware description language is one of VDHL and Verilog.

13. The system according to claim 10, wherein from the same input file, the compiler can selectively generate output files which describe both transmit and receive state machines.

14. The system according to claim 10, wherein optimization of the state machine is achieved by:
identifying sequences of states in the input file that repeat;
collapsing the identified sequence into a single state in the output file; and,
wrapping a counter around the single state.

15. The system according to claim 10, wherein a BNF style notation is used for the source code.
